(19) United States
(12) Patent Application Publication
(10) Pub. No.: US 2008/0055051 A1
(43) Pub. Date: Mar. 6, 2008

(54) Electronic notification system

(76) Inventors: Steven Snyder, American Fork, UT (US); Lynn Jones, Las Vegas, NV (US); Trevan Richine, Springville, UT (US); Bryan Snyder, Rancho Cucamonga, CA (US)

Correspondence Address: SANDRA LEE LIPKIN;A LAW CORPORATION, 1891 GOODYEAR AVE., SUITE 622, VENTURA, CA, 93003, US

(21) Appl. No.: 11/897,660

(22) Filed: Aug. 31, 2007

Related U.S. Application Data
(60) Provisional application No. 60/842,197, filed on Aug. 31, 2006.

(51) Int. Cl. G08B 5/00

(52) U.S. Cl. 340/286.09

(57) ABSTRACT

An electronic notification system that allows primarily for patrons of a business, such as a restaurant or other establishment, to use his or her telephone or other device having internet access to make a reservation, see wait times, make special requests and receive a telephone call once a table is ready or other service is available. The system also provides information to business establishments on clients including, telephone number, preferences and the like. The system can also be broadly used by establishments who have established a customer database of telephone numbers to wage mass telephone marketing campaigns at once to notify patrons of upcoming events and offers. To business establishment users, reports can be made on marketing data and other information collected during use.

### REFERENCE TO PRIOR APPLICATION

This application claims the priority of provisional application 60/842,197, filed Aug. 31, 2006 entitled ELECTRONIC NOTIFICATION SYSTEM by Steven Snyder, Lynn Jones, Trevan Richins and Bryan Snyder.

### BACKGROUND OF THE INVENTION

1. Field of the Invention

The present invention relates generally to the field of notification systems and more particularly to a system that allows for electronic notification to businesses of a variety of information from patrons utilizing telephones and personal computers.

2. Description of the Prior Art

When persons patronize various restaurants for meals, often there are long waits to be seated. In the past, this hurdle has been overcome by the placement of a reservation, usually made directly over the telephone between the patron and personnel at the restaurant. When making a reservation the restaurant knows when the patron will arrive and the patron can count on a table without waiting.

In addition to this mode of reserving a place to be seated at a restaurant, for persons who have not made reservations, electronic paging devices have been given to patrons at some establishments in the past. Using this method, when a table is ready, these devices indicate through vibration and/or noise that there is a table ready for the patron and the patron can then be seated.

The present invention seeks to combine and improve upon these two concepts, i.e., reservations for a table made electronically via the Internet or telephonically, combined with an electronic notification system utilizing the patron's telephone number, be it a land line or a cellular phone. Additionally, this electronic notification system can be used for other business establishments, such as retail establishments like auto dealerships and pharmacies, whom wish to electronically offer marketing deals and campaigns to multiple telephone recipients at once.

### SUMMARY OF THE INVENTION

The preferred embodiment of the present invention teaches an electronic paging system comprising a server; a localized computer at the site of a business that will be paging a patron that is connected to the server; means for the patron to provide information to the server; means for the business to contact the patron with desired information.

The above embodiment can be further modified by defining that the means for the patron to provide information to the server is taken from the group consisting of: accessing the server through the patron's personal computer and an internet connection connecting to the business's website, directly dialing the business through a telephone, and entering the information at the site of the business through a kiosk that is connected to the website.

The above embodiment can be further modified by defining that the means for the business to contact the patron is a voice-over internet protocol system.

The above embodiment can be further modified by defining that the information to be provided by the patron is taken from a group consisting of: name identifier, number of people requiring service, patron preferences, and return phone number.

The above embodiment can be further modified by defining that the information is stored in a database on the server.

The above embodiment can be further modified by defining that the information is categorizable by the business for the purpose of generating reports on the information, customizable by the business, the reports to contain information from the group consisting of: wait times and patron preferences.

The above embodiment can be further modified by defining that the business can modify the information in the database for the viewing by the patron on the website.

The above embodiment can be further modified by defining that the patron can download software to the patron's cell phone and view the information in the database.

An alternate embodiment teaches a method for a patron to reserve a table at a restaurant and be notified of the availability of the table comprising making a reservation by the patron wherein the patron provides identifying information to the restaurant; adding the patron information onto a server which adds the patron to a waiting list; the waiting list is reloaded and wait time recalculated with the addition of the patron information; notifying the patron when a table is ready; patron responding to the notification; resetting of the waiting list; and recalculating the wait time.

The above embodiment can be further modified by defining that the reservation is made through a step taken from the group consisting of: contacting the restaurant through a direct dial telephone, by accessing a website programmed to do so through the patron's personal computer and an internet connection, or by accessing the server programmed to do so through a kiosk on site at that restaurant that accesses the server and the website.

The above embodiment can be further modified by defining that the identifying information is taken from the group consisting of: name identifier, number of people in party, patron preferences, and return phone number.

The above embodiment can be further modified by defining that the means to notify the patron is a voice-over internet protocol system.

The above embodiment can be further modified by defining that the patron response to the notification is taken from the group consisting of: returning to the restaurant to be seated, calling the restaurant to make changes through a bridging system that designates the pressing of a designated button that will call the restaurant, opting to be removed from the list through the pressing of a designated button and canceling the reservation.

The above embodiment can be further modified by defining that the notification provides the patron with a caller identification identifying the call as originating from the restaurant.

The above embodiment can be further modified by defining that the information is stored in a database on the server.

The above embodiment can be further modified by defining that the information is categorizable by the restaurant for the purpose of generating reports on the information, customizable by the business, the reports to contain information from the group consisting of: wait times and patron preferences.

The above embodiment can be further modified by defining that the restaurant can modify the information in the database for the viewing by the a patron.

The above embodiment can be further modified by defining that the patron can download software to the patron's cell phone and view the information in the database.

An alternate embodiment provides for a method for notifying a plurality of parties of a specific message comprising dialing a plurality of phone numbers with a single recorded message simultaneously utilizing voice-over internet protocol the plurality of phone numbers being retrieved from a previously built database.

### BRIEF DESCRIPTION OF THE DRAWINGS

FIG. 1 is FIG. 1 is a flow chart of the Network and Communication System.

FIG. 2 is a detailed flow chart of the system as it applies to reservations made at a restaurant.

### DETAILED DESCRIPTION OF A PREFERRED EMBODIMENT

Turning to the drawings, the preferred embodiment is illustrated and described by reference characters that denote similar elements throughout the several views of the instant invention.

The instant invention involves a computer network for providing paging services, via the internet, to and between multiple sources and users, including, but not limited to, restaurants and their patrons. Patron information, including a name identifier, the number in the party, and telephone number, are entered into the network in a variety of ways. One way is via direct-dial telephone, another is through the internet via the end user's personal computer. Another way is through a web browser on a patron's cell phone which can access the Internet. Alternatively information can be entered directly on site. Information is stored in a database which presents the patron's name on the restaurant's local computer.

When a table is available the restaurant employee selects the party for paging. The patron is then paged via voice-over-internet protocol (VOIP) to the telephone number provided by the patron along with a personalized greeting requesting that the user return to the establishment to be seated. The patron will be provided with the option of calling the establishment directly for any further requests or changes. When the patron's telephone rings, the caller ID will identify the restaurant as the caller.

The Internet-based paging system is usable in multiple settings, including but not limited to restaurants, hotels, hospitals, retail establishments, etc. The system also provides information that is unavailable to the patron user. This information includes current wait time, employee feedback, customized voice messages, etc. This system utilizes the patron's telephone to inform them that their wait is over. The system utilizes VOIP and a ten-key data entry device.

When the user logs in to the Internet (the user can be the establishment or the patron or someone acting on the patron's behalf and goes to the website, there are entry fields for the patron's name, the number in the party, preferences, notes and the patron's telephone number. The webpage is customizable by the restaurant or other business establishment using customizing menu items on the webpage. After making the reservation, the user can see on line how long the wait is. The system is made possible through a specially created software algorithm.

Once the patron has been seated, the patron's name disappears from the list. By utilizing the Notes data entry field, the client can specify preferences, such as taste for sushi or the need for a high chair. The restaurant client will have a drop down menu to keep track of client preferences such as a non-smoking section or an outside table.

The tabs on the webpage allow both the patron and the restaurant to change settings and/or retrieve information. The restaurant patron, however, is not privy to as much information as the client restaurant. A restaurant client has access to a variety of information. For example, a cancelled list will include patrons who did not show up for their table one time. This list can be accessed and the patron's place in the queue reactivated should the patron show up to the restaurant after being placed on the cancelled list.

Additionally, a reports tab will provide information regarding wait times and party size to the establishments as well as other customizable reports. The reservations page can take the user to the restaurant they desire, categorized by state on the system's home page. The guests tab allows establishments who specialize in catering to high clients to track information about their clients, including food allergies, wine preferences, etc.

There are Admin and Admin Help tabs that allow the establishments to control passwords and to change preferences of the look of the webpage, contact information, seating preferences, etc. Help tabs help teach the use of the Admin and Guest List features of the website. Only those given access by the establishments will be able to access the Reports and Admin tabs, but all other tabs should be accessible to all restaurant client users. The reports tab will have a number of pre-made reports that can show, among other things, the average number of people making reservations, the average wait, and other variations on collected information.

Additionally, the patron client will be able to download software onto his or her cellular phone to wait times, position on the list, etc. Also, the system can identify if the phone was answered by an answering machine/voice mail or by an actual person and will notify the restaurant if no actual person was reached or if a person received the call.

Restaurants will be able to indicate on the website which hours are available for reservations. The system will be able to handle restaurant seating, i.e., it will be able to identify parties that can be seated; it will show how full the restaurant is as well as any other information that is helpful to the restaurant while dealing with seating. The system will be able to monitor the relative business of a restaurant and indicate to the restaurant management if more servers would be advisable on given days or at certain hours.

An additional option will be a button on the website that will allow either the patron or the food serving establishment to call 911 with a pre-recorded message identifying a need for help while also supplying the address and contact information.

This system can also be utilized by retail establishments of all sorts who collect patron telephone information and other marketing information. Once a database of patron telephone numbers is established (can be as little as one patron), the retail or other business establishment has the capability of waging a marketing campaign that can call multiple numbers at once, e.g., numbering thousands of phone calls at a time.

For example, if a car dealership user wishes to announce to its customer list of an upcoming holiday sale, the system can be programmed to send out pre-recorded messages to patrons announcing the sale or other promotion all at once.

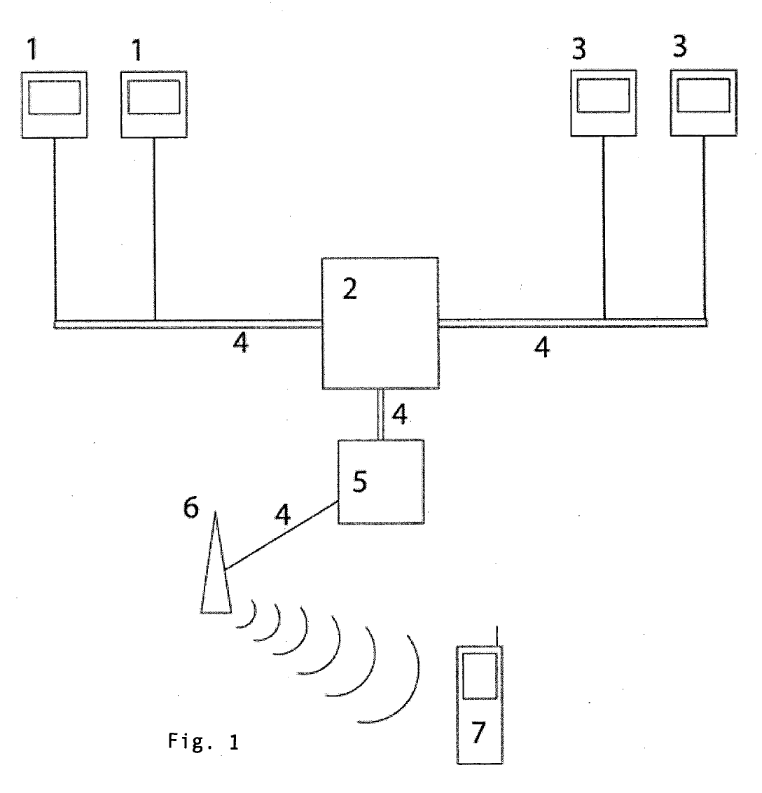

As seen in FIG. 1, the general system is outlined. Personal computers (1) access the server system (2) which is also accessible by the subscribing computer terminals (3) through the internet (4). The server (2) accesses the VOIP (5) through the Internet (4) which then contacts a cell phone tower (6) through the Internet (4) which then rings the patron's cell phone (7).

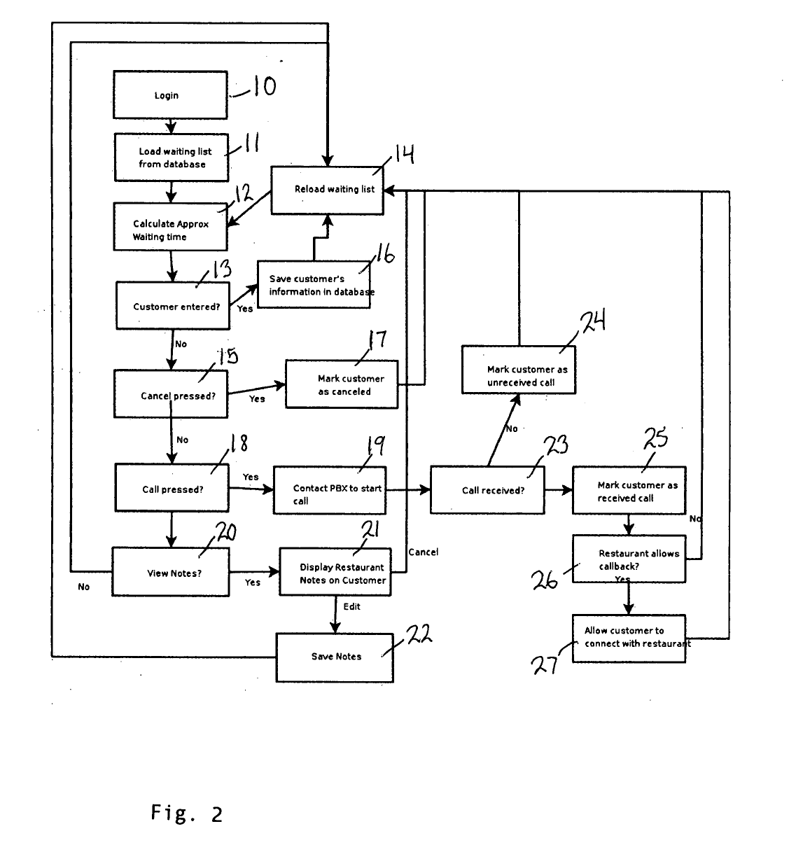

FIG. 2 illustrates a flow chart of how the system would typically work in the instance it is being used to make reservations at a restaurant. This chart starts with the user logging in to the system 10. The user then waits for the waiting list to load from the database 11. The approximate wait time is then calculated 12. The customer can then enter his information 13, which will be entered into the database 16 or cancel his request 15 depending on the wait time.

If the client wishes to cancel, he can press the cancel button 15 which will mark the customer as cancelled 17 and the waiting time will again be recalculated 14 for remaining guests on the list.

If the client wishes to remain on the list, the customer waits for a call from the establishment notifying him or her that the table is ready 18, 19. The customer then has the option of calling the establishment directly. If the patron takes the call, it is marked received in the system 23. If the call is not received by the patron 24, then the it is marked as an unreceived call and the wait time is again recalculated 14.

Optionally, the establishment can view customer notes 20 and display the notes on the establishment computer 21. If appropriate, the reservation can be cancelled and the waiting list recalculated 14. Client notes can be edited and saved 22.

An option is whether or not the restaurant allows a callback 26. If it does, then it can allow the customer to connected with the restaurant 27 and again recalculate the wait time 14. If it does not, then the wait time is automatically recalculated 14.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. An electronic paging system comprising
a server;
a localized computer at the site of a business that will be paging a patron said computer being connected to said server;
means for said patron to provide information to said server;
means for said business to contact said patron with desired information.

2. An electronic paging system as defined in claim 1 wherein said means for said patron to provide information to said server is taken from the group consisting of: accessing said server through said patron's personal computer and an internet connection connecting to said business's website, directly dialing said business through a telephone, using a web browser through a cellular phone or other Internet-accessing device and entering said information at the site of said business through a kiosk that is connected to said website.

3. An electronic paging system as defined in claim 1 wherein said means for said business to contact said patron is a voice-over internet protocol system.

4. An electronic paging system as defined in claim 1 wherein said information to be provided by said patron is taken from a group consisting of: name identifier, number of people requiring service, patron preferences, and return phone number.

5. An electronic paging system as defined in claim 4 wherein said information is stored in a database on said server.

6. An electronic paging system as defined in claim 4 wherein said information is categorizable by said business for the purpose of generating reports on said information, customizable by said business, said reports to contain information from the group consisting of: wait times and patron preferences.

7. An electronic paging system as defined in claim 6 wherein said business can modify said information in said database for the viewing by said patron on said website.

8. An electronic paging system as defined in claim 7 wherein said patron can download software to said patron's cell phone and view said information in said database.

9. A method for a patron to reserve a table at a restaurant and be notified of the availability of said table comprising
making a reservation by said patron wherein said patron provides identifying information to said restaurant;
adding said patron information onto a server which adds said patron to a waiting list;
said waiting list is reloaded and wait time recalculated with the addition of said patron information;
notifying said patron when a table is ready;
patron responding to said notification;
resetting of said waiting list; and
recalculating said wait time.

10. A method as defined in claim 9 wherein said reservation is made through a step taken from the group consisting of: contacting said restaurant through a direct dial telephone, by accessing a website programmed to do so through said patron's personal computer and an internet connection, or by accessing said server programmed to do so through a kiosk on site at said restaurant that accesses said server and said website.

11. A method as defined in claim 9 wherein said identifying information is taken from the group consisting of: name identifier, number of people in party, patron preferences, and return phone number.

12. A method as defined in claim 9 wherein said means to notify said patron is a voice-over internet protocol system.

13. A method as defined in claim 9 wherein said patron response to said notification is taken from the group consisting of: returning to the restaurant to be seated, calling the restaurant to make changes through a bridging system that designates the pressing of a designated button that will call the restaurant, opting to be removed from the list through the pressing of a designated button, and canceling said reservation.

14. A method as defined in claim 12 wherein said notification provides the patron with a caller identification identifying the call as originating from said restaurant.

15. A method as defined in claim 11 wherein said information is stored in a database on said server.

16. A method as defined in claim 11 wherein said information is categorizable by said restaurant for the purpose of generating reports on said information, customizable by said business, said reports to contain information from the group consisting of: wait times and patron preferences.

17. A method as defined in claim 16 wherein said restaurant can modify said information in said database for the viewing by said a patron.

18. A method as defined in claim 17 wherein said patron can download software to said patron's cell phone and view said information in said database.

19. A method for notifying a plurality of parties of a specific message comprising
dialing a plurality of phone numbers with a single recorded message simultaneously utilizing voice-over internet protocol said plurality of phone numbers being retrieved from a previously built database.
